(19) United States
(12) Patent Application Publication
(10) Pub. No.: US 2015/0184728 A1
(43) Pub. Date: Jul. 2, 2015

(54) Automatic Transmission Having A Continuously Variable Transmission Assembly

(71) Applicant: AVL Powertrain Engineering, Inc., Plymouth, MI (US)

(72) Inventor: Gregory MORDUKHOVICH, Bloomfield Hills, MI (US)

(21) Appl. No.: 14/576,892

(22) Filed: Dec. 19, 2014

Related U.S. Application Data
(60) Provisional application No. 61/922,214, filed on Dec. 31, 2013.

(51) Int. Cl. F16H 9/12; F16H 47/06; F16H 61/70; F16H 37/02

(52) U.S. Cl. CPC F16H 9/125; F16H 37/021; F16H 47/06; F16H 61/70

(57) ABSTRACT

An automatic transmission is disclosed including a continuously variable transmission assembly having a first pulley and a second pulley. At least one of the pulleys has a variable operating diameter to provide a variable ratio. A first gear assembly and a second gear assembly are provided each including at least one forward gear. The forward gears have different diameters and are numbered consecutively in the order of increasing diameter. The continuously variable transmission assembly also has at least one pulley actuator that selectively adjusts the variable diameter of the at least one of the pulleys to change the variable ratio of the continuously variable transmission assembly in response to a shift between the at least one forward gear of the first gear assembly and the at least one forward gear of the second gear assembly.

### CROSS-REFERENCE TO RELATED APPLICATIONS

This application claims the benefit of U.S. Provisional Application No. 61/922,214, filed on Dec. 31, 2013. The entire disclosure of the above application is incorporated herein by reference.

### FIELD

The subject disclosure relates to automatic transmissions. More particularly, the following disclosure describes an automatic transmission for coupling with an engine and a drivetrain. Such a transmission may find utility when used in a vehicle such as, but not limited to, an automobile.

### BACKGROUND

This section provides background information related to the present application which is not necessarily prior art.

Automatic transmissions are widely used to transfer the power generated by an engine to the drivetrain of a vehicle. Particularly in the automobile industry, the design of automatic transmissions has become a renewed area of focus due to increasing market demand for vehicles that are fuel efficient and environmentally friendly. Improved automatic transmissions provide a cost effective alternative to hybridization and electrification options. Specifically, automatic transmissions with larger total ratio spreads allow for engine downsizing while maintaining drivability.

To achieve larger total ratio spreads and greater fuel economy over a wide range of vehicle speeds, many newer automatic transmission designs utilize a large number of forward gears. For example, ZF Friedrichshafen AG manufactures an 8 HP eight-speed planetary automatic transmission with a total ratio spread of 7.05 and a 9 HP nine-speed planetary automatic transmission with a total ratio spread of 9.81. However, automatic transmissions utilizing many step-gear ratios, such as those noted above, have several drawbacks. First, the cost, complexity, envelope size, and weight of an automatic transmission increases as additional forward gears are added. This increases vehicle cost and service cost and the added complexity can negatively impact reliability. The added size and weight can also hinder overall vehicle performance and fuel economy. Second, ratio increases in automatic transmissions by the addition of forward gears and shifting elements leads to an efficiency reduction of the automatic transmission due to additional frictional losses and losses associated with extra rotational mass and inertia.

In an effort to overcome some of the drawbacks of automatic transmissions with many step-gear ratios, various designs for continuously variable transmissions have been explored. Continuously variable transmissions typically have a smaller envelope and weigh less when compared to automatic transmissions with many step-gear ratios. Also, by offering an infinite number of ratios, continuously variable transmissions provide optimum gearing over a wide range of vehicle speeds. However, the total ratio spread of a continuously variable transmission is limited by the size and geometry of the pulleys and is small in comparison to the total ratio spread of automatic transmissions with many step-gear ratios. To increase the total ratio spread of the continuously variable transmission, some designs add two forward gears to a continuously variable transmission. For example, Jatco Ltd. manufactures a CVT7 continuously variable transmission that has two forward gears providing a total ratio spread of 7.3 and a CVT8 continuously variable transmission that has two forward gears providing a total ratio spread of 7.0. While these modified continuously variable transmission designs provide larger total ratio spreads than a conventional continuously variable transmission, the total ratio spread is still considerably less than leading automatic transmissions that have many step-gear ratios. Accordingly, these modified continuously variable transmissions do not provide the same engine downsizing benefits. Further, continuously variable transmissions are most efficient at a ratio of one to one (1:1). The efficiency of a continuously variable transmission decreases rapidly as the ratio increases or decreases from the one to one (1:1) ratio. Accordingly, continuously variable transmissions suffer from efficiency drawbacks over much of their operating range, where the continuously variable transmission is not operating at a ratio of one to one (1:1).

What is needed is an automatic transmission that has a large total ratio spread for engine downsizing without the drawbacks associated with adding a large number of step gears or running a continuously variable transmission at less efficient ratios to achieve a larger total ratio spread.

### SUMMARY

This section provides a general summary of the disclosure, and is not a comprehensive disclosure of its full scope or all of its features.

The present disclosure provides an automatic transmission including an input shaft and a continuously variable transmission assembly. The continuously variable transmission assembly includes a first pulley and a second pulley. The first pulley is rotatably coupled with the input shaft. The second pulley is laterally spaced from the first pulley. At least one of the pulleys has a variable operating diameter that provides a variable gear ratio. The continuously variable transmission assembly also includes a belt that rotatably couples the first pulley and the second pulley. The automatic transmission also includes a first gear assembly and a second gear assembly each including at least one forward gear. The forward gears have different diameters and are numbered consecutively in order of increasing diameter. The automatic transmission also includes a first clutch selectively coupling the first pulley and the first gear assembly and a second clutch selectively coupling the second pulley and the second gear assembly. A third gear assembly is disposed in meshing engagement with the at least one forward gear of the first gear assembly and the at least one forward gear of the second gear assembly. The third gear assembly further includes an output shaft. The continuously variable transmission assembly has at least one pulley actuator that selectively adjusts the variable diameter of at least one of the pulleys to change the variable ratio of the continuously variable transmission assembly in response to a shift between the at least one forward gear of the first gear assembly and the at least one forward gear of the second gear assembly.

The disclosed automatic transmission uses the continuously variable transmission assembly to effectuate shifts between forward gears. By adjusting the variable ratio of the continuously variable transmission in response to a shift between forward gears, the at least one pulley actuator allows the continuously variable transmission to act as a filler between the forward gears and minimizes the torque variation during a shift. Accordingly, the step between the forward gears can be increased, which results in a corresponding increase in the total effective ratio spread.

A method of operating an automatic transmission is also provided. The method includes providing a first forward gear, a second forward gear, and a continuously variable transmission assembly. The continuously variable transmission assembly is rotatably coupled to the first forward gear and the second forward gear. The continuously variable transmission assembly also has a variable ratio that is adjusted by at least one pulley actuator. The method includes the steps of engaging one of the first forward gear and the second forward gear, controlling the at least one pulley actuator to set the variable ratio of the continuously variable transmission assembly to a pre-determined ratio when one of the first and second forward gears is engaged, shifting between the first and second forward gears, controlling the at least one pulley actuator to change the variable ratio of the continuously variable transmission assembly to a ratio that is different from the pre-determined ratio during the shifting step, and controlling the at least one pulley actuator to re-set the variable ratio of the continuously variable transmission assembly to the pre-determined ratio after the shifting step has been completed.

Advantageously, the disclosed automatic transmission and method can provide large total effective ratio spreads by increasing the steps between the forward gears instead of adding extra forward gears. Further, instead of running the continuously variable transmission at less efficient ratios for long periods of time to achieve a larger total ratio spread, the disclosed automatic transmission accomplishes a larger total effective ratio spread by increasing the steps between the forward gears. The disclosed automatic transmission utilizes the variable ratio of the continuously variable transmission to minimize torque variation during shifts between forward gears. Such shifts are finite in time and the continuously variable transmission can be run at more efficient ratios, such as a ratio of one to one (1:1), when a forward gear is selected. Accordingly, the continuously variable transmission may be operated at less efficient ratios only for short periods of time where shifts between forward gears are required.

The disclosed automatic transmission does not suffer from the cost, complexity, envelope size, and weight penalties of automatic transmissions that have eight or nine forward gears. The disclosed automatic transmission is also more efficient because fewer forward gears can be used to achieve a large total effective ratio spread leading to less frictional losses and losses associated with the extra rotational mass and inertia of additional forward gears. The disclosed automatic transmission also provides a larger total effective ratio over existing continuously variable transmissions that feature two forward gears. This translates to increased engine downsizing capability. The disclosed automatic transmission is also more efficient than existing continuously variable transmissions that feature two forward gears because the continuously variable transmission is not run at less efficient ratios over much of its operating range. Instead, the variable ratio of the continuously variable transmission is primarily utilized as a filler between forward gears to help effectuate gear shifts.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of an exemplary automatic transmission constructed in accordance with the present disclosure shown with an optional torque converter, pulley bypass clutch and reverse gear;

FIG. 2 is a schematic diagram of another exemplary automatic transmission constructed in accordance with the present disclosure shown with an optional torque converter, but no pulley bypass clutch or reverse gear;

FIG. 3 is a schematic diagram of another exemplary automatic transmission constructed in accordance with the present disclosure that has no torque converter, pulley bypass clutch, or reverse gear;

FIG. 4 is a plot illustrating an exemplary upshift between the first forward gear and the second forward gear of an exemplary automatic transmission disclosed herein;

FIG. 5 is a plot illustrating another exemplary upshift between the first forward gear and the second forward gear of an exemplary automatic transmission disclosed herein;

FIG. 6 is a plot illustrating an exemplary downshift between the second forward gear and the first forward gear of an exemplary automatic transmission disclosed herein; and

FIG. 7 is a plot illustrating another exemplary downshift between the second forward gear and the first forward gear of an exemplary automatic transmission disclosed herein.

### DETAILED DESCRIPTION

Referring to the Figures generally, wherein like numerals indicate corresponding parts throughout the several views, an automatic transmission 20 is disclosed. More particularly, the following disclosure describes an automatic transmission 20 for coupling with an engine and a drivetrain. Such an automatic transmission 20 may find use in a vehicle such as, but not limited to, an automobile.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

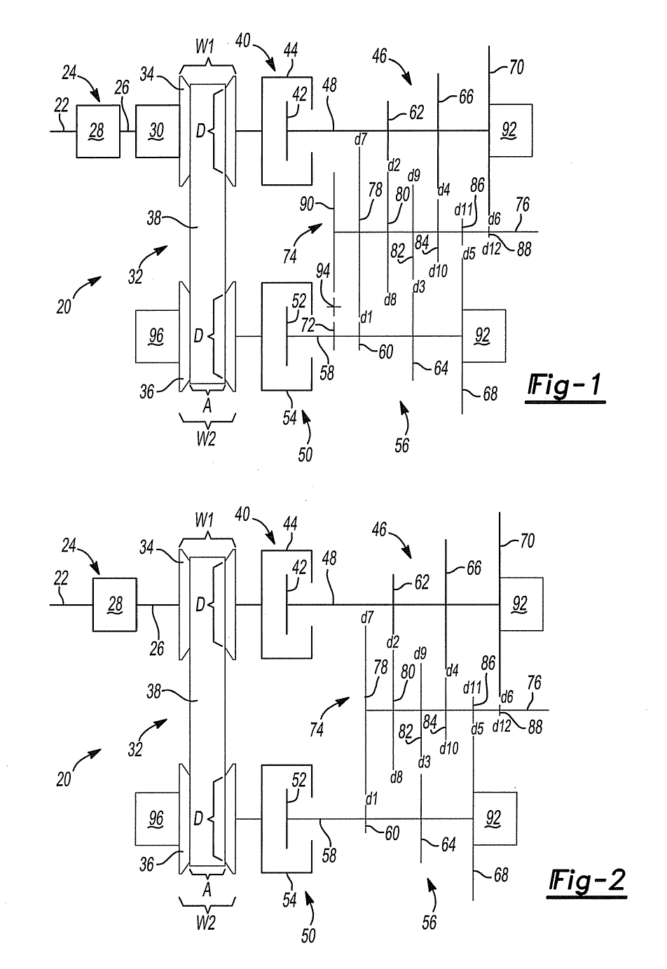

With reference to FIG. 1, the automatic transmission 20 includes an input shaft 22. The input shaft 22 is rotatably coupled with the engine and is generally driven by the engine. A torque converter 24 may be optionally provided. When present, the torque converter 24 is rotatably coupled to the input shaft 22 for receiving torque from the engine through the rotation of the input shaft 22. The torque converter 24 has an output member 26 opposite the input shaft 22 and a lockup clutch assembly 28 selectively coupling rotation of the input shaft 22 and the output member 26. As such, the torque converter 24 aids in launching the vehicle without stalling the engine by providing some slip between the input shaft 22 and the output member 26 of the torque converter 24. A pulley bypass clutch 30 may also be optionally provided. When present, the pulley bypass clutch 30 is rotatably coupled to the output member 26 of the torque converter 24.

The automatic transmission 20 includes a continuously variable transmission assembly 32 including a first pulley 34 and a second pulley 36. The first pulley 34 is selectively coupled to the input shaft 22. More particularly, the first pulley 34 is selectively coupled to the input shaft 22 through the torque converter 24 and pulley bypass clutch 30 where these optional elements are present. The second pulley 36 of the continuously variable transmission assembly 32 is laterally spaced from the first pulley 34. At least one of the first pulley 34 and the second pulley 36 has a variable operating diameter D to provide a variable ratio for the continuously variable transmission assembly 32. Preferably, both the first pulley 34 and the second pulley 36 have a variable operating diameter D. The continuously variable transmission assembly 32 further includes a belt 38 rotatably coupling the first pulley 34 and the second pulley 36. In this way, the belt 38 transfers rotational energy of the first pulley 34 to the second pulley 36. Both the first pulley 34 and the second pulley 36 each have an axial contact area A that may generally be defined as the area where the belt 38 engages the first pulley 34 and the second pulley 36. This axial contact area A may generally correspond with (i.e. overlaps) a width W1 of the first pulley 34 and a width W2 of the second pulley 36, which may be variable and/or dissimilar from the axial contact area A.

The automatic transmission 20 includes a first clutch 40 rotatably coupled with the first pulley 34. The first clutch 40 includes a first clutch plate 42 and a first clutch brake 44. The first clutch 40 may have a drum-like configuration where the first clutch plate 42 rotates within the first clutch brake 44. The first clutch brake 44 selectively engages the first clutch plate 42 to rotatably couple the first clutch plate 42 and the first pulley 34. A first gear assembly 46 is rotatably coupled with the first clutch plate 42. The first gear assembly 46 may take the form of either a planetary gear set or a layshaft gear set. Where the first gear assembly 46 is a layshaft gear set, the first gear assembly 46 includes a first layshaft 48 rotatably coupled with the first clutch plate 42.

The automatic transmission 20 also includes a second clutch 50. The second clutch 50 is rotatably coupled with the second pulley 36. The second clutch 50 includes a second clutch plate 52 and a second clutch brake 54. Like with the first clutch 40, the second clutch 50 may have a drum-like configuration where the second clutch plate 52 rotates within the second clutch brake 54. The second clutch brake 54 selectively engages the second clutch plate 52 to rotatably couple the second clutch plate 52 and the second pulley 36. A second gear assembly 56 is rotatably coupled with the second clutch plate 52. The second gear assembly 56 may take the form or either a planetary gear set or a layshaft gear set. Where the second gear assembly 56 is a layshaft gear set, the second gear assembly 56 includes a second layshaft 58 rotatably coupled with the second clutch plate 52.

The first gear assembly 46 and the second gear assembly 56 each include at least one forward gear 60, 62, 64, 66, 68, 70. Accordingly, the automatic transmission 20 includes at least two forward gears 60, 62, 64, 66, 68, 70, one that is part of the first gear assembly 46 and another that is part of the second gear assembly 56. However, various configurations are possible. By way of example and without limitation, the automatic transmission 20 disclosed may have two, three, four, five, six, seven, eight, or nine forward gears.

One such exemplary automatic transmission 20 is disclosed with six forward gears 60, 62, 64, 66, 68, 70. According to this implementation, the second gear assembly 56 includes a first forward gear 60. The first forward gear 60 is rotatably coupled with the second layshaft 58 and has a first diameter d1. The first gear assembly 46 includes a second forward gear 62 that is rotatably coupled with the first layshaft 48 and has a second diameter d2 that is larger than the first diameter d1 of the first forward gear 60. The second gear assembly 56 also includes a third forward gear 64 that is rotatably coupled with the second layshaft 58 and has a third diameter d3 that is larger than the second diameter d2 of the second forward gear 62. The first gear assembly 46 also includes a fourth forward gear 66 that is rotatably coupled with the first layshaft 48 and has a fourth diameter d4 that is larger than the third diameter d3 of the third forward gear 64. The second gear assembly 56 additionally includes a fifth forward gear 68 that is rotatably coupled with the second layshaft 58 and has a fifth diameter d5 that is larger than the fourth diameter d4 of the fourth forward gear 66. The first gear assembly 46 additionally includes a sixth forward gear 70 that is rotatably coupled with the first layshaft 48 and has a sixth diameter d6 that is larger than the fifth diameter d5 of the fifth forward gear 68. The second gear assembly 56 may further include a reverse gear 72 rotatably coupled with the second layshaft 58.

Each consecutively higher numbered forward gear has a diameter that is greater than the diameter of the forward gear before it. Accordingly, each consecutively higher numbered forward gear provides a lower gear ratio. The first forward gear 60 may generally coincide with low speed travel of the vehicle, while the sixth forward gear 70 may generally coincide with high speed travel of the vehicle. As explained above, the first gear assembly 46 includes the even numbered forward gears 62, 66, 70, those including the second forward gear 62, the fourth forward gear 66, and the sixth forward gear 70. Meanwhile, the second gear assembly 56 includes the odd numbered forward gears 60, 64, 68, those including the first forward gear 60, the third forward gear 64, and the fifth forward gear 68. The second gear assembly 56 may also include the reverse gear 72. Of course, other arrangements of the forward gears 60, 62, 64, 66, 68, 70 and the reverse gear 72 are possible and are within the scope of the subject disclosure.

The automatic transmission 20 further includes a third gear assembly 74 disposed in meshing engagement with the first gear assembly 46 and the second gear assembly 56. The third gear assembly 74 is thus selectively driven by the first gear assembly 46 and the second gear assembly 56 and presents an output shaft 76 for coupling with the drivetrain of the vehicle. The third gear assembly 74 includes a first output gear 78 rotatably coupled with the output shaft 76. The first output gear 78 is disposed in meshing engagement with the first forward gear 60 of the second gear assembly 56 and has a seventh diameter d7. The third gear assembly 74 includes a second output gear 80 rotatably coupled with the output shaft 76. The second output gear 80 is disposed in meshing engagement with the second forward gear 62 of the first gear assembly 46 and has an eighth diameter d8 that is smaller than the seventh diameter d7 of the first output gear 78. The third gear assembly 74 includes a third output gear 82 rotatably coupled with the output shaft 76. The third output gear 82 is disposed in and meshing engagement with the third forward gear 64 of the second gear assembly 56 and has a ninth diameter d9 that is smaller than the eighth diameter d8 of the second output gear 80. The third gear assembly 74 includes a fourth output gear 84 rotatably coupled with the output shaft 76. The fourth output gear 84 is disposed in meshing engagement with the fourth forward gear 66 of the first gear assembly 46 and has a tenth diameter d10 that is smaller than the ninth diameter d9 of the third output gear 82. The third gear assembly 74 includes a fifth output gear 86 rotatably coupled with the output shaft 76. The fifth output gear 86 is disposed in meshing engagement with the fifth forward gear 68 of the second gear assembly 56 and has an eleventh diameter d11 that is smaller than the tenth diameter d10 of the fourth output gear 84. The third gear assembly 74 further includes a sixth output gear 88 rotatably coupled with the output shaft 76. The sixth output gear 88 is disposed in meshing engagement with the sixth forward gear 70 of the first gear assembly 46 and has a twelfth diameter d12 that is smaller than the eleventh diameter d11 of the fifth output gear 86. The third gear assembly 74 may optionally include a reverse output gear 90 rotatably coupled with the output shaft 76. When present, the reverse output gear 90 is disposed in meshing engagement with the reverse gear 72 of either the first gear assembly 46 or the second gear assembly 56.

The forward gears 60, 62, 64, 66, 68, 70 of the first gear assembly 46 and the second gear assembly 56 are arranged to have a wide step ratio between consecutively numbered forward gears 60, 62, 64, 66, 68, 70. This means that there is a wide step, or wide ratio change, between the first forward gear 60 and the second forward gear 62, the second forward gear 62 and the third forward gear 64, the third forward gear 64 and the fourth forward gear 66, the fourth forward gear 66 and the fifth forward gear 68, and between the fifth forward gear 68 and the sixth forward gear 70. The automatic transmission 20 includes at least one step-gear actuator 92 that selectively engages and disengages the forward gears 62, 66, 70 of the first gear assembly 46 and the forward gears 60, 64, 68 of the second gear assembly 56 to shift the automatic transmission 20 between consecutively numbered forward gears 60, 62, 64, 66, 68, 70. Although other arrangements are possible, each of the forward gears 62, 66, 70 of the first gear assembly 46 may be carried on the first layshaft 48 such that the first layshaft 48 is free to rotate relative to forward gears 62, 66, 70, when forward gears 62, 66, 70 have not been engaged by the at least one step-gear actuator 92. When the at least one step-gear actuator 92 engages one of the forward gears 62, 66, 70 of the first gear assembly 46, the at least one step-gear actuator 92 rotatably couples the engaged gear to the first layshaft 48 such that the first layshaft 48 drives the engaged gear. Similarly, each of the forward gears 60, 64, 68 of the second gear assembly 56 may be carried on the second layshaft 58 such that the second layshaft 58 is free to rotate relative to forward gears 60, 64, 68, when forward gears 60, 64, 68 have not been engaged by the at least one step-gear actuator 92. When the at least one step-gear actuator 92 engages one of the forward gears 60, 64, 68 of the second gear assembly 56, the at least one step-gear actuator 92 rotatably couples the engaged gear to the second layshaft 58 such that the second layshaft 58 drives the engaged gear. Engagement of the reverse gear 72 is accomplished this same way.

There may be multiple step-gear actuators 92 with one for each forward gear 60, 62, 64, 66, 68, 70 or gear change between forward gears 60, 62, 64, 66, 68, 70. There may be multiple step-gear actuators 92 with one for the forward gears 62, 66, 70 of the first gear assembly 46 and another for the forward gears 60, 64, 68 of the second gear assembly 56. Alternatively, a single step-gear actuator 92 may control the shifting and engagement of all forward gears 60, 62, 64, 66, 68, 70. Where a reverse gear 72 is provided, the automatic transmission 20 may include at least one reverse gear actuator 94 that selectively engages and disengages the reverse gear 72 (FIG. 1). Alternatively, the step-gear actuator 92 that controls shifting and engagement of the forward gears 60, 62, 64, 66, 68, 70 may be utilized to also selectively engage and disengage the reverse gear 72.

The continuously variable transmission assembly 32 of the automatic transmission 20 further includes at least one pulley actuator 96 that selectively adjusts the variable diameter D of at least one of the first pulley 34 and the second pulley 36 to increase the variable ratio of the continuously variable transmission assembly 32 in response to a shift between consecutively numbered forward gears 60, 62, 64, 66, 68, 70. Although a variety of configurations are possible, the first pulley 34 and/or the second pulley 36 may have an hour-glass shape with opposing sides. The at least one pulley actuator 96 may adjust the variable diameter D of the first pulley 34 and/or the second pulley 36 at the axial contact area A by adjusting the spacing of the opposing sides of the first pulley 34 and/or the second pulley 36. In other words, the at least one pulley actuator 96 can adjust the variable diameter D of the first pulley 34 and/or the second pulley 36 at the segment where the belt 38 rides the first pulley 34 and/or the second pulley 36 by compressing or expanding the hour-glass shape of the first pulley 34 and/or the second pulley 36.

The at least one pulley actuator 96 may adjust the variable diameter D of the first pulley 34 and the variable diameter D of the second pulley 36 to provide a first ratio in response to the at least one step-gear actuator 92 selectively engaging one of the forward gears 60, 62, 64, 66, 68, 70. The first ratio may be equal to a ratio of one to one (1:1). The at least one pulley actuator 96 may also adjust the variable diameter D of the first pulley 34 and the variable diameter D of the second pulley 36 to change the variable ratio of the continuously variable transmission assembly 32 to a second ratio that is different than the first ratio in response to the at least one step-gear actuator 92 shifting between consecutive forward gears 60, 62, 64, 66, 68, 70.

For example and without limitation, the at least one pulley actuator 96 may decrease the variable ratio of the continuously variable transmission assembly 32 to a second ratio that is less than one to one (1:1) in response to an upshift from a lower numbered forward gear to a higher numbered forward gear. The at least one pulley actuator 96 may increase the variable ratio of the continuously variable transmission assembly 32 to a second ratio that is greater than one to one (1:1) in response to an downshift from a higher numbered forward gear to a lower numbered forward gear. Accordingly, the at least one pulley actuator 96 changes the variable ratio of the continuously variable transmission assembly 32 to facilitate shifts between the wide step ratio forward gears 60, 62, 64, 66, 68, 70. If the at least one pulley actuator 96 did not change the variable ratio of the continuously variable transmission assembly 32 to facilitate shifts, such shifts could not occur smoothly and/or without damage to the automatic transmission 20 due to large torque variations resulting from the wide step ratio between the forward gears 60, 62, 64, 66, 68, 70. In this way, utilization of the wide step ratio of the forward gears 60, 62, 64, 66, 68, 70 is made possible because the at least one pulley actuator 96 adjusts the variable ratio of the continuously variable transmission assembly 32 to facilitate shifts.

Still referring to FIG. 1, the automatic transmission 20 is illustrated with the pulley bypass clutch 30. The first pulley 34 is driven at the same rotational rate as the output member 26 of the torque converter 24 in response to the pulley bypass clutch 30 being engaged. The first pulley 34 is rotationally disconnected from the output member 26 of the torque converter 24 in response to the pulley bypass clutch 30 being disengaged. The output member 26 extends through the first pulley 34 such that torque is delivered to the first clutch 40, and thus the first gear assembly 46, when the pulley bypass clutch 30 is disengaged. In other words, the first pulley 34 is supported on the output member 26 and can rotate relative to the output member 26 when the pulley bypass clutch 30 is disengaged. Engagement of the pulley bypass clutch 30 therefore couples the first pulley 34 with the output member 26 such that the first pulley 34 rotates with the output member 26.

Spinning losses associated with rotationally driving the first pulley 34 and the second pulley 36 of the continuously variable transmission assembly 32 can be eliminated by disengaging the pulley bypass clutch 30 for improved efficiency. For example, the forward gears 62, 66, 70 of the first gear assembly 46 can be selected as preferred gears for increased efficiency. Specifically, the pulley bypass clutch 30 may be disengaged in response to the at least one step-gear actuator 92 engaging one of the forward gears 62, 66, 70 of the first gear assembly 46. This eliminates spinning losses associated with the continuously variable transmission assembly 32 when even numbered forward gears 62, 66, 70 are engaged (the second forward gear 62, the fourth forward gear 66, or the sixth forward gear 70). It should of course be appreciated that the pulley bypass clutch 30 may alternatively be connected to the second pulley 36, or the forward gears 62, 66, 70 of the first gear assembly 46 may be reversed, such that the pulley bypass clutch 30 would eliminate the spinning losses of the continuously variable transmission assembly 32 when odd numbered forward gears 60, 64, 68 are engaged (the first forward gear 60, the third forward gear 64, or the fifth forward gear 68).

Referring now to FIG. 2, the automatic transmission 20 assembly is illustrated without the pulley bypass clutch 30. Accordingly, in this configuration the first pulley 34 of the continuously variable transmission assembly 32 cannot be disconnected from rotation with the output member 26 of the torque converter 24 and there are no preferred forward gears where the spinning losses associated with the continuously variable transmission assembly 32 can be eliminated. However, in accordance with the present disclosure, the at least one pulley actuator 96 may adjust the variable diameter D of the first pulley 34 and the variable diameter D of the second pulley 36 to provide a first ratio of one to one (1:1) in response to the at least one step-gear actuator 92 selectively engaging one of the forward gears 60, 62, 64, 66, 68, 70. While the spinning losses associated with the continuously variable transmission assembly 32 are not eliminated, they are minimized because the continuously variable transmission assembly 32 is most efficient when operating at a first ratio of one to one (1:1). As such, the continuously variable transmission assembly 32 operates at a more efficient ratio when a forward gear is selected and operates at a less efficient ratio for only short durations when there is a shift between the forward gears 60, 62, 64, 66, 68, 70.

The steps between consecutively numbered forward gears 60, 62, 64, 66, 68, 70 may be determined by the variable ratio of the continuously variable transmission assembly 32. The continuously variable transmission assembly 32 has a ratio spread ranging between a maximum ratio and a minimum ratio. Larger steps between consecutively number forward gears 60, 62, 64, 66, 68, 70 can be utilized when the ratio spread of the continuously variable transmission assembly 32 is increased. Advantageously, larger steps between consecutively numbered forward gears 60, 62, 64, 66, 68, 70 increase the total effective ratio range of the automatic transmission 20. This is desirable because a smaller engine can be fitted in the vehicle while maintaining drivability. As a result, fuel economy is enhanced and emissions are reduced. Increasing the total effective ratio range of an automatic transmission 20 also appears to be more cost effective in comparison with hybridization and electrification options. Larger steps between consecutively number forward gears 60, 62, 64, 66, 68, 70 also enable the use of fewer forward gears to achieve the same total effective ratio range. By eliminating forward gears, for example by using six wide step forward gears 60, 62, 64, 66, 68, 70 instead of eight or nine forward gears, efficiency benefits can be realized by eliminating the frictional losses, extra mass, and inertia losses associated with extra forward gears.

By using the continuously variable transmission assembly 32 to ease shifts between consecutively numbered forward gears 60, 62, 64, 66, 68, 70, the continuously variable transmission assembly 32 acts as a filler bridging the wide step ratios between consecutively numbered forward gears 60, 62, 64, 66, 68, 70 to minimize torque variation during shifts. Minimizing the role of the continuously variable transmission assembly 32 to this filler function, the continuously variable transmission assembly 32 can be optimized for efficiency in this limited use. Specifically, the variable diameter D of the first pulley 34 and the second pulley 36 of the continuously variable transmission assembly 32 can be reduced compared to conventional continuously variable transmissions because a large ratio spread is not required when the continuously variable transmission assembly 32 is utilized as a filler between consecutively numbered forward gears 60, 62, 64, 66, 68, 70. The axial contact area A of the first pulley 34 and the second pulley 36 can also be reduced compared to conventional continuously variable transmissions since the proposed duty cycle of the continuously variable transmission assembly 32 is less than that of conventional continuously variable transmissions. These design changes lead to mass and design envelope reduction over conventional continuously variable transmissions. Also, the decreased severity of the first pulley 34 and second pulley 36 duty cycle may enable the usage of lower viscosity fluids leading to additional reductions in traction losses, churning losses, and pumping loses associated with rotation of the first pulley 34, the second pulley 36, the first clutch 40, the second clutch 50, the first gear assembly 46, the second gear assembly 56, and the third gear assembly 74 in a lubricating fluid.

Referring now to FIG. 3, the automatic transmission 20 assembly is illustrated without the pulley bypass clutch 30 and the torque converter 24. Accordingly, in this configuration the first pulley 34 of the continuously variable transmission assembly 32 cannot be disconnected from rotation with the input shaft 22. In the absence of the torque converter 24, the continuously variable transmission assembly 32 is also utilized to prevent engine stalls during the launch of the vehicle from a standstill. In this configuration, the at least one pulley actuator 96 selectively adjusts the variable diameter D of at least one of the first pulley 34 and the second pulley 36 to increase the variable ratio of the continuously variable transmission assembly 32 in response to a shift from neutral to the first forward gear 60. By combining the increased variable ratio of the continuously variable transmission assembly 32 with the first forward gear 60 of a fixed ratio, the total effective ratio at vehicle launch is high enough that engine stall conditions are avoided. Sometime after the vehicle is moving, the variable ratio of the continuously variable transmission assembly 32 returns to the first ratio until another shift is effectuated.

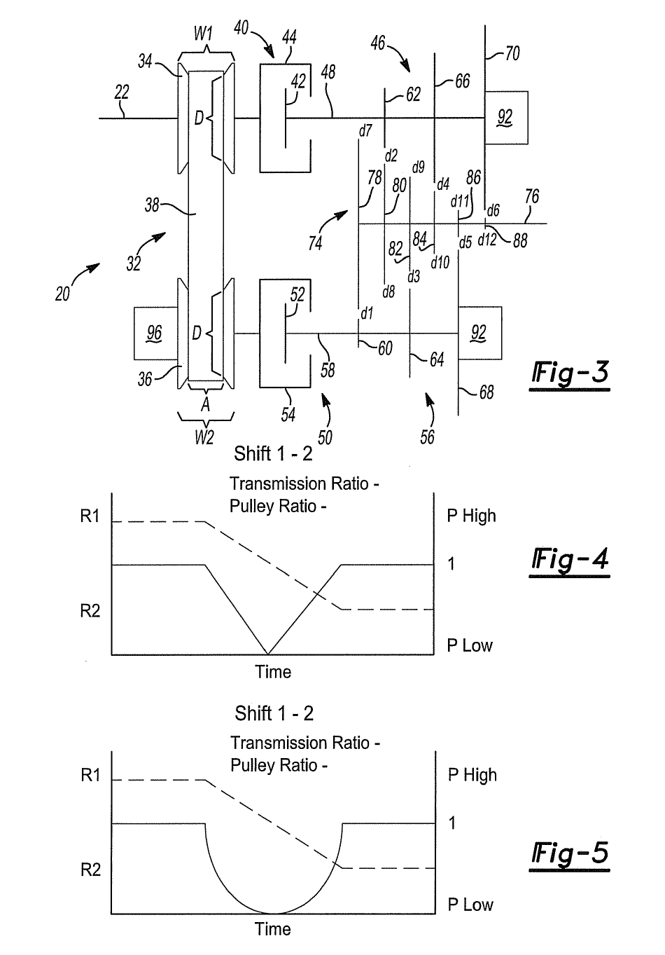

Referring now to FIG. 4, a plot is provided illustrating an exemplary upshift between the first forward gear 60 and the second forward gear 62 of the automatic transmission 20. The y-axis on the left-hand side of FIG. 4 represents the fixed ratios of the first forward gear 60 and the second forward gear 62. The y-axis on the right-hand side of FIG. 4 represents the variable ratio of the continuously variable transmission assembly 32. The x-axis represents the time during which the automatic transmission 20 shifts between the first forward gear 60 and the second forward gear 62. The first forward gear 60 has a first fixed ratio R1 that corresponds to the first diameter d1 of the first forward gear 60 and the seventh diameter d7 of the first output gear 78. The second forward gear 62 has a second fixed ratio R2 that corresponds to the second diameter d2 of the second forward gear 62 and the eighth diameter d8 of the second output gear 80. The dashed line illustrates the wide step ratio between the first forward gear 60 and the second forward gear 62. The solid line illustrates how the at least one pulley actuator 96 dynamically adjusts the variable ratio of the continuously variable transmission assembly 32 during a shift from the first forward gear 60 to the second forward gear 62. Specifically, the at least one pulley actuator 96 linearly decreases the variable ratio of the continuously variable transmission assembly 32 from the first ratio of one to one (1:1) to a second ratio equaling a minimum ratio P Low. As shown in Tables 3 and 4 below, the minimum ratio P Low for the continuously variable transmission assembly 32 could equal, for example, 0.67. Once the second ratio equaling the minimum ratio P Low is reached, the at least one pulley actuator 96 linearly increases the variable ratio of the continuously variable transmission assembly 32 from the second ratio back to the first ratio equaling one to one (1:1). This dynamically adjustment of the variable ratio of the continuously variable transmission assembly 32 during a shift from the first forward gear 60 to the second forward gear 62 allows the continuously variable transmission assembly 32 to act as a filler between the first forward gear 60 to the second forward gear 62 so that upshifts can be accomplished with minimal noise, vibration, and harshness—even when there is a wide step ratio between the first forward gear 60 to the second forward gear 62.

Now referring to FIG. 5, a plot is provided illustrating another exemplary upshift between the first forward gear 60 and the second forward gear 62 of the automatic transmission 20. The shift sequence in FIG. 5 is similar to that of FIG. 4 except that in FIG. 5 the at least one pulley actuator 96 exponentially or nonlinearly decreases the variable ratio of the continuously variable transmission assembly 32 from the first ratio of one to one (1:1) to a second ratio equaling the minimum ratio P Low. Once the second ratio equaling the minimum ratio P Low is reached, the at least one pulley actuator 96 exponentially or nonlinearly increases the variable ratio of the continuously variable transmission assembly 32 from the second ratio back to the first ratio equaling one to one (1:1).

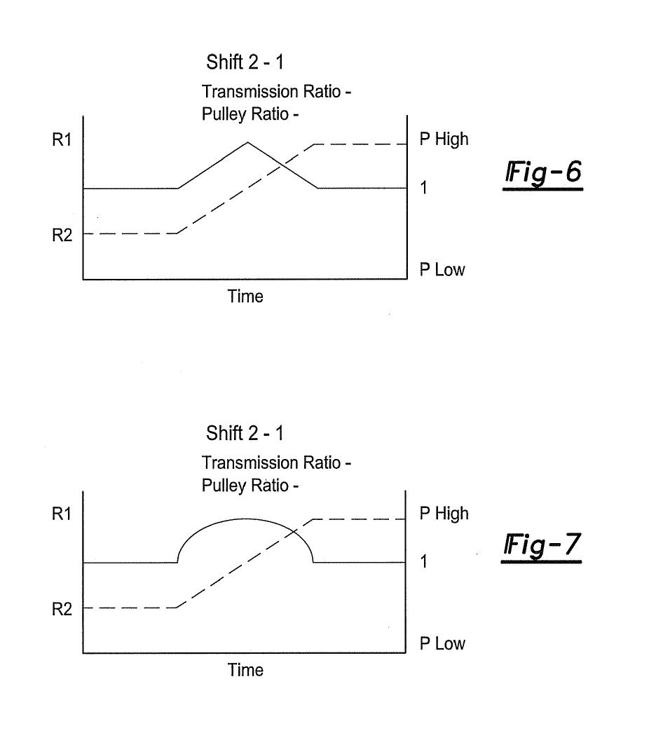

Referring now to FIG. 6, a plot is provided illustrating an exemplary downshift between the second forward gear 62 and the first forward gear 60 of the automatic transmission 20. The y-axis on the left-hand side of FIG. 6 represents the fixed ratios of the first forward gear 60 and the second forward gear 62. The y-axis on the right-hand side of FIG. 6 represents the variable ratio of the continuously variable transmission assembly 32. The x-axis represents the time during which the automatic transmission 20 shifts between the second forward gear 62 and the first forward gear 60. The first forward gear 60 has a first fixed ratio R1 that corresponds to the first diameter d1 of the first forward gear 60 and the seventh diameter d7 of the first output gear 78. The second forward gear 62 has a second fixed ratio R2 that corresponds to the second diameter d2 of the second forward gear 62 and the eighth diameter d8 of the second output gear 80. The dashed line illustrates the wide step ratio between the first forward gear 60 and the second forward gear 62. The solid line illustrates how the at least one pulley actuator 96 dynamically adjusts the variable ratio of the continuously variable transmission assembly 32 during a shift from the second forward gear 62 to the first forward gear 60. Specifically, the at least one pulley actuator 96 linearly increases the variable ratio of the continuously variable transmission assembly 32 from the first ratio of one to one (1:1) to a second ratio equaling a maximum ratio P High. As shown in Tables 3 and 4 below, the maximum ratio P High for the continuously variable transmission assembly 32 could equal, for example, 1.5. Once the second ratio equaling the maximum ratio P High is reached, the at least one pulley actuator 96 linearly decreases the variable ratio of the continuously variable transmission assembly 32 from the second ratio back to the first ratio equaling one to one (1:1). This dynamically adjustment of the variable ratio of the continuously variable transmission assembly 32 during a shift from the second forward gear 62 to the first forward gear 60 allows the continuously variable transmission assembly 32 to act as a filler between the second forward gear 62 to the first forward gear 60 so that downshifts can be accomplished with minimal noise, vibration, and harshness—even when there is a wide step ratio between the second forward gear 62 to the first forward gear 60.

Now referring to FIG. 7, a plot is provided illustrating another exemplary downshift between the second forward gear 62 and the first forward gear 60 of the automatic transmission 20. The shift sequence in FIG. 7 is similar to that of FIG. 6 except that in FIG. 7 the at least one pulley actuator 96 exponentially or nonlinearly increases the variable ratio of the continuously variable transmission assembly 32 from the first ratio of one to one (1:1) to a second ratio equaling the maximum ratio P High. Once the second ratio equaling the maximum ratio P High is reached, the at least one pulley actuator 96 exponentially or nonlinearly decreases the variable ratio of the continuously variable transmission assembly 32 from the second ratio back to the first ratio equaling one to one (1:1).

The plots and tables that follow illustrate several examples of the automatic transmission 20 disclosed. Obviously, these exemplary configurations can be modified without departing from the scope of the present disclosure. According to one configuration, the continuously variable transmission assembly 32 may be coupled to a 4L60-E four-speed automatic transmission 20 manufactured by General Motors. The 4L60-E automatic transmission 20 of this configuration has a 4.395 total ratio and the continuously variable transmission assembly 32 used in this configuration has a 2.25 ratio spread. Referring to Plot 1 and Table 1 (below), the first forward gear 60 of the automatic transmission 20 has a fixed ratio of 3.059. With the continuously variable transmission assembly 32 engaged, the first forward gear 60 spans a number of ratios ranging from a high limit of 4.589 to a low limit of 2.039. The second forward gear 62 of the automatic transmission 20 has a fixed ratio of 1.625. With the continuously variable transmission assembly 32 engaged, the second forward gear 62 spans a number of ratios ranging from a high limit of 2.438 to a low limit of 1.083. The third forward gear 64 of the automatic transmission 20 has a fixed ratio of 1.000. With the continuously variable transmission assembly 32 engaged, the third forward gear 64 spans a number of ratios ranging from a high limit of 1.500 to a low limit of 0.667. The fourth forward gear 66 of the automatic transmission 20 has a fixed ratio of 0.696. With the continuously variable transmission assembly 32 engaged, the fourth forward gear 66 spans a number of ratios ranging from a high limit of 1.044 to a low limit of 0.464. Finally, the reverse gear 72 of the automatic transmission 20 has a fixed ratio of 2.294. With the continuously variable transmission assembly 32 engaged, the reverse gear 72 spans a number of ratios ranging from a high limit of 3.441 to a low limit of 1.539. The high level of gear overlap of the automatic transmission 20 allows for smoother shifts and a total effective ratio spread equaling 9.889.

TABLE 1
Total Ratio Range 9.889

| | | High Limit | Low Limit |
|---|---|---|---|
| 1 | 3.059 | 4.589 | 2.039 |
| 2 | 1.625 | 2.438 | 1.083 |
| 3 | 1 | 1.500 | 0.667 |
| 4 | 0.696 | 1.044 | 0.464 |
| R | 2.294 | 3.441 | 1.539 |

Referring now to Plot 2 and Table 2 (below), another configuration is shown utilizing an automatic transmission 20 that has a wide step ratio between the forward gears 60, 62, 64, 66, 68, 70. Again, the continuously variable transmission assembly 32 used in this configuration has a 2.25 ratio spread. Advantageously, the continuously variable transmission assembly 32 permits shifts between these wide step ratio forward gears 60, 62, 64, 66, 68, 70 and ultimately results in a higher total effective ratio spread. The first forward gear 60 of the automatic transmission 20 has a fixed ratio of 4.74. With the continuously variable transmission assembly 32 engaged, the first forward gear 60 spans a number of ratios ranging from a high limit of 7.11 to a low limit of 3.16. Advantageously, the high limit of 7.11 for the first forward gear 60 is high enough that the vehicle can be launched in the absence of a torque converter 24 without engine stall conditions occurring. The second forward gear 62 of the automatic transmission 20 has a fixed ratio of 2.18. With the continuously variable transmission assembly 32 engaged, the second forward gear 62 spans a number of ratios ranging from a high limit of 3.27 to a low limit of 1.45. The third forward gear 64 of the automatic transmission 20 has a fixed ratio of 1.00. With the continuously variable transmission assembly 32 engaged, the third forward gear 64 spans a number of ratios ranging from a high limit of 1.50 to a low limit of 0.67. The fourth forward gear 66 of the automatic transmission 20 has a fixed ratio of 0.45. With the continuously variable transmission assembly 32 engaged, the fourth forward gear 66 spans a number of ratios ranging from a high limit of 0.67 to a low limit of 0.30. The reverse gear 72 of the automatic transmission 20 has a fixed ratio of 3.56. With the continuously variable transmission assembly 32 engaged, the reverse gear 72 spans a number of ratios ranging from a high limit of 5.33 to a low limit of 2.37.

It should be appreciated that the term “wide step ratio” as used herein, describes a gearset that has a large gap or ratio spread between sequential gears. The gearset has a wide step ratio if the gap or ratio spread between two sequential gears (i.e. between a higher numbered gear and the next lower numbered gear) is greater than or equal to the gear ratio of the sequentially higher numbered gear. As shown in Table 2 for example, the wide step ratio or gap between the first forward gear 60 and the second forward gear 62 is 2.56, which is larger than the gear ratio of 2.18 for the second forward gear 62. Similarly, the wide step ratio or gap between the second forward gear 62 and the third forward gear 64 is 1.18, which is larger than the gear ratio of 1.00 for the third forward gear 64. Finally, the wide step ratio or gap between the third forward gear 64 and the fourth forward gear 66 is 0.55, which is larger than the gear ratio of 0.45 of the fourth forward gear 66. Even with the wide step ratios between the forward gears 60, 62, 64, 66, 68, 70, the variable ratio and “filler” function of the continuously variable transmission assembly 32 provides sufficient gear overlap to allow shifts and the total effective ratio spread equals 10.56. Accordingly, such an automatic transmission 20 allows for engine downsizing.

TABLE 2
Total Ratio 23.76
Effective Ratio 10.56

| | | High Limit | Low Limit |
|---|---|---|---|
| 1 | 4.74 | 7.11 | 3.16 |
| 2 | 2.18 | 3.27 | 1.45 |
| 3 | 1.00 | 1.50 | 0.67 |
| 4 | 0.45 | 0.67 | 0.30 |
| R | 3.56 | 5.33 | 2.37 |

By coupling the continuously variable transmission assembly 32 to the four speed automatic transmission 20 of Plot 2 and Table 2, many ratio options also become available for the different forward gears 60, 62, 64, 66, 68, 70. As illustrated in Plots 3, 4, and 5 and in Tables 3, 4, and 5 (below), three different ratios are available for each forward gear depending on the variable ratio of the continuously variable transmission. For example, the variable ratio of the continuously variable transmission may be adjusted by the at least one pulley actuator 96 to give the first forward gear 60 a standard ratio 1 of 4.74 when the variable ratio of the continuously variable transmission is set to 1.00, a low ratio 1 L of 7.11 when the variable ratio of the continuously variable transmission is set to 1.50, and a high ratio 1H of 3.16 when the variable ratio of the continuously variable transmission is set to 0.67. This may be done for one or more of the forward gears 60, 62, 64, 66, 68, 70.

TABLE 3

| | | | Fixed Ratio |
|---|---|---|---|
| | Total Ratio | CVT Ratio | Ratio |
| 1L | 7.11 | 1.5 | 4.74 |
| 1 | 4.74 | 1 | 4.74 |
| 1H | 3.16 | 0.67 | 4.74 |
| 2L | 3.27 | 1.5 | 2.18 |
| 2 | 2.18 | 1 | 2.18 |
| 2H | 1.45 | 0.67 | 2.18 |
| 3L | 1.50 | 1.5 | 1.50 |
| 3 | 1.00 | 1 | 1.50 |
| 3H | 0.67 | 0.67 | 1.50 |
| 4L | .067 | 1.5 | 0.45 |
| 4 | 0.45 | 1 | 0.45 |
| 4H | 0.30 | 0.67 | 0.45 |

TABLE 4

| | | | Fixed Ratio |
|---|---|---|---|
| | Total Ratio | CVT Ratio | Ratio |
| 1L | 7.11 | 1.5 | 4.74 |
| 1 | 4.74 | 1 | 4.74 |
| 1H | 3.16 | 0.67 | 4.74 |
| 2 | 2.18 | 1 | 2.18 |
| 2H | 1.45 | 0.67 | 2.18 |
| 3 | 1.00 | 1 | 1.50 |
| 3H | 0.67 | 0.67 | 1.50 |
| 4 | 0.45 | 1 | .045 |
| 4H | 0.30 | 0.67 | .045 |

TABLE 5

| | | | Fixed Ratio |
|---|---|---|---|
| | Total Ratio | CVT Ratio | Ratio |
| 1L | 7.11 | 1.5 | 4.74 |
| 1 | 4.74 | 1 | 4.74 |
| 2L | 3.27 | 1.5 | 2.18 |
| 2 | 2.18 | 1 | 2.18 |
| 3L | 1.50 | 1.5 | 1.50 |
| 3 | 1.00 | 1 | 1.50 |
| 4L | 0.67 | 1.5 | 0.45 |
| 4 | 0.45 | 1 | .045 |
| 4H | 0.30 | 0.67 | .045 |

A method of operating the automatic transmission 20 described above is also disclosed. The method comprises several steps, which are described below. The method includes the step of providing a first forward gear 60, a second forward gear 62, and a continuously variable transmission assembly 32. The first forward gear 60 is part of a first gear assembly 46 and the second forward gear 62 is part of a second gear assembly 56. The continuously variable transmission assembly 32 is rotatably coupled to the first gear assembly 46 and the second gear assembly 56. The continuously variable transmission assembly 32 also has a variable ratio that is adjusted by at least one pulley actuator 96. Generally, the method also includes the steps of engaging one of the first forward gear 60 and the second forward gear 62, controlling the at least one pulley actuator 96 to set the variable ratio of the continuously variable transmission assembly 32 to a pre-determined ratio when one of the first and second forward gears 60, 62 is engaged, shifting between the first and second forward gears 60, 62, controlling the at least one pulley actuator 96 to change the variable ratio of the continuously variable transmission assembly 32 to a ratio that is different from the pre-determined ratio during the shifting step, and controlling the at least one pulley actuator 96 to re-set the variable ratio of the continuously variable transmission assembly 32 to the pre-determined ratio after the shifting step has been completed.

It should be appreciated that the disclosed method may be used to effectuate upshifts and downshifts. To effectuate an upshift, the method may include the steps of engaging the first forward gear 60 of the first gear assembly 46 and controlling the at least one pulley actuator 96 to set the variable ratio of the continuously variable transmission assembly 32 to the pre-determined ratio when the first forward gear 60 is engaged. The method may proceed with the step of shifting from the first forward gear 60 of the first gear assembly 46 to the second forward gear 62 of the second gear assembly 56 by disengaging the first forward gear 60 and engaging the second forward gear 62. The method may include controlling the at least one pulley actuator 96 to decrease the variable ratio of the continuously variable transmission assembly 32 to a ratio that is less than the pre-determined ratio during the step of shifting from the first forward gear 60 to the second forward gear 62. The method may also call for controlling the at least one pulley actuator 96 to re-set the variable ratio of the continuously variable transmission assembly 32 to the pre-determined ratio after the step of shifting from the first forward gear 60 to the second forward gear 62 has been completed and when the second forward gear 62 is engaged. To effectuate a downshift, the method may include the step of shifting from the second forward gear 62 of the second gear assembly 56 to the first forward gear 60 of the first gear assembly 46 by disengaging the second forward gear 62 and engaging the first forward gear 60. The method may include controlling the at least one pulley actuator 96 to increase the variable ratio of the continuously variable transmission assembly 32 to a ratio that is greater than the pre-determined ratio during the step of shifting from the second forward gear 62 to the first forward gear 60. The method may additionally include the step of controlling the at least one pulley actuator 96 to re-set the variable ratio of the continuously variable transmission assembly 32 to the pre-determined ratio after the step of shifting from the second forward gear 62 to the first forward gear 60 has been completed and when the first forward gear 60 is engaged.

The at least one pulley actuator 96 sets the pre-determined ratio of the continuously variable transmission assembly 32 to a constant value when either of the first and second forward gears 60, 62 is engaged. The pre-determined ratio set by the at least one pulley actuator 96 may more specifically be set to equal a ratio of one to one (1:1). As explained above, this reduces the inefficiencies of the continuously variable transmission assembly 32, since the continuously variable transmission assembly 32 is most efficient at a ratio of one to one (1:1). Notwithstanding, the pre-determined ratio may be set as any other specific ratio if desired. As illustrated in FIGS. 4-7, the at least one pulley actuator 96 may change or adjust the variable ratio from the pre-determined ratio progressively with time. FIGS. 4 and 6 show that the at least one pulley actuator 96 may change the variable ratio from the pre-determined ratio linearly with time. Alternatively, FIGS. 5 and 7 show that the at least one pulley actuator 96 may change the variable ratio from the pre-determined ratio exponentially with time. Of course, any number of forward gears and reverse gears may be added and the disclosed method may be applied to accommodate shifts between these additional gears in the same manner as shifts between the first and second forward gears 60, 62 are treated. It should be understood that the steps of the disclosed method may be performed in another order than that listed without departing from the scope of the subject disclosure. Further, the method may include additional intervening steps that may be performed between or concurrently with the steps listed above without departing from the scope of the subject disclosure.

The foregoing description of the embodiments has been provided for the purposes of illustration and description. It is not intended to be exhaustive or limiting. Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. An automatic transmission, comprising:
an input shaft;
a continuously variable transmission assembly including a first pulley rotatably coupled with said input shaft and a second pulley laterally spaced from said first pulley and at least one of said first pulley and said second pulley having a variable operating diameter to provide a variable ratio;
said continuously variable transmission assembly including a belt rotatably coupling said first pulley and said second pulley;
a first gear assembly and a second gear assembly each including at least one forward gear, said forward gears having different diameters;
a first clutch selectively coupling said first pulley and said first gear assembly;
a second clutch selectively coupling said second pulley and said second gear assembly;
a third gear assembly disposed in meshing engagement with said at least one forward gear of said first gear assembly and said at least one forward gear of said second gear assembly;
said third gear assembly including an output shaft; and
said continuously variable transmission assembly having at least one pulley actuator selectively adjusting said variable diameter of said at least one of said first pulley and said second pulley to change said variable ratio of said continuously variable transmission assembly during a shift between said at least one forward gear of said first gear assembly and said at least one forward gear of said second gear assembly.

2. An automatic transmission as set forth in claim 1 wherein said at least one pulley actuator decreases said variable ratio of said continuously variable transmission assembly in response to an upshift from one of said forward gears having a lower number to one of said forward gears having a higher number.

3. An automatic transmission as set forth in claim 1 wherein said at least one pulley actuator increases said variable ratio of said continuously variable transmission assembly in response to a downshift from one of said forward gears having a higher number to one of said forward gears having a lower number.

4. An automatic transmission as set forth in claim 1 wherein said at least one forward gear of said first gear assembly and said at least one forward gear of said second gear assembly have a wide step ratio therebetween.

5. An automatic transmission as set forth in claim 1 wherein said first pulley is permanently coupled to said input shaft.

6. An automatic transmission as set forth in claim 1 further including a pulley bypass clutch selectively coupling said input shaft to said first pulley for rotation therewith.

7. An automatic transmission as set forth in claim 6 wherein said first clutch includes a first clutch plate and a first clutch brake, said first clutch brake selectively engaging said first clutch plate to rotatably couple said first pulley and said first gear assembly.

8. An automatic transmission as set forth in claim 7 wherein said first gear assembly includes a first layshaft rotatably coupled with said first clutch plate.

9. An automatic transmission as set forth in claim 8 wherein said second clutch includes a second clutch plate and a second clutch brake, said second clutch brake selectively engaging said second clutch plate to rotatably couple said second pulley and said second gear assembly.

10. An automatic transmission as set forth in claim 9 wherein said second gear assembly includes a second layshaft rotatably coupled with said second clutch plate.

11. An automatic transmission as set forth in claim 10 further including a torque converter rotatably coupled to the input shaft for receiving torque from the input shaft.

12. An automatic transmission as set forth in claim 11 wherein said torque converter includes an output member and a lockup clutch assembly selectively coupling said output member to said input shaft for rotation therewith.

13. An automatic transmission as set forth in claim 12 wherein said first pulley is permanently coupled to said output member.

14. An automatic transmission as set forth in claim 10 wherein said at least one forward gear of said second gear assembly includes a first forward gear rotatably coupled with said second layshaft and having a first diameter.

15. An automatic transmission as set forth in claim 14 wherein said at least one forward gear of said first gear assembly includes a second forward gear rotatably coupled with said first layshaft and having a second diameter that is larger than said first diameter.

16. An automatic transmission as set forth in claim 15 wherein said at least one forward gear of said second gear assembly includes a third forward gear rotatably coupled with said second layshaft and having a third diameter that is larger than said second diameter.

17. An automatic transmission as set forth in claim 16 wherein said at least one forward gear of said first gear assembly includes a fourth forward gear rotatably coupled with said first layshaft and having a fourth diameter that is larger than said third diameter.

18. An automatic transmission as set forth in claim 17 further including at least one step-gear actuator selectively engaging and disengaging said forward gears of said first gear assembly and said second gear assembly to shift the automatic transmission between consecutive forward gears.

19. An automatic transmission as set forth in claim 18 wherein said third gear assembly includes an output shaft.

20. An automatic transmission as set forth in claim 19 wherein said third gear assembly includes at least a first output gear rotatably coupled with said output shaft and meshingly engaged with said first forward gear and a second output gear rotatably coupled with said output shaft and meshingly engaged with said second forward gear and a third output gear rotatably coupled with said output shaft and meshingly engaged with said third forward gear and a fourth output gear rotatably coupled with said output shaft and meshingly engaged with said fourth forward gear.

21. An assembly as set forth in claim 1 wherein said input shaft is rotatably coupled with an engine.

22. An automatic transmission for coupling with an engine, comprising:
an input shaft rotatably coupled with the engine;
a continuously variable transmission assembly including a first pulley coupled to said input shaft and a second pulley laterally spaced from said first pulley;
said first pulley and said second pulley each having a variable operating diameter to provide a variable ratio of said continuously variable transmission assembly;
said continuously variable transmission assembly including a belt rotatably coupling said first pulley and said second pulley;
a first clutch rotatably coupled with said first pulley including a first clutch plate and a first clutch brake that selectively engages said first clutch plate to rotatably couple said first clutch plate and said first pulley;
a first gear assembly rotatably coupled with said first clutch plate including a first layshaft rotatably coupled with said first clutch plate;
a second clutch rotatably coupled with said second pulley including a second clutch plate and a second clutch brake that selectively engages said second clutch plate to rotatably couple said second clutch plate and said second pulley;
a second gear assembly rotatably coupled with said second clutch plate including a second layshaft rotatably coupled with said second clutch plate;
said first gear assembly and said second gear assembly each including at least one forward gear;
said second gear assembly including a first forward gear rotatably coupled with said second layshaft and having a first diameter;
said first gear assembly including a second forward gear rotatably coupled with said first layshaft and having a second diameter that is larger than said first diameter;
a third gear assembly disposed in meshing engagement with said first gear assembly and said second gear assembly;
said third gear assembly including an output shaft;
said third gear assembly including a first output gear rotatably coupled with said output shaft and meshingly engaged with said first forward gear;
said third gear assembly including a second output gear rotatably coupled with said output shaft and meshingly engaged with said second forward gear;
said forward gears of said first gear assembly and said second gear assembly having a wide step ratio between consecutive forward gears;
at least one step-gear actuator selectively engaging and disengaging said forward gears of said first gear assembly and said forward gears of said second gear assembly to shift the automatic transmission between consecutive forward gears; and
said continuously variable transmission assembly having at least one pulley actuator selectively adjusting said variable diameter of said first pulley and said variable diameter of said second pulley to provide a first ratio of one to one in response to said at least one step-gear actuator selectively engaging one of said forward gears and said at least one pulley actuator increasing said variable ratio of said continuously variable transmission assembly to a second ratio that is different than said first ratio in response to said at least one step-gear actuator shifting between consecutive forward gears.

23. An automatic transmission as set forth in claim 22 wherein said at least one pulley actuator adjusts said second ratio to a value that is less than one to one in response to said step-gear actuator making an upshift from one of said forward gears having a lower number to one of said forward gears having a higher number.

24. An automatic transmission as set forth in claim 22 wherein said at least one pulley actuator adjusts said second ratio to a value that is greater than one to one in response to said step-gear actuator making a downshift from one of said forward gears having a higher number to one of said forward gears having a lower number.

25. An automatic transmission for coupling with an engine, comprising:
an input shaft rotatably coupled with the engine;
a torque converter rotatably coupled to the input shaft for receiving torque from the input shaft;
said torque converter having an output member opposite said input shaft;
said torque converter including a lockup clutch assembly selectively coupling rotation of said input shaft and said output member;
a pulley bypass clutch rotatably coupled to said output member of said torque converter;
a continuously variable transmission assembly including a first pulley selectively coupled to said pulley bypass clutch and a second pulley laterally spaced from said first pulley;
said first pulley and said second pulley each having a variable operating diameter to provide a variable ratio of said continuously variable transmission assembly;
said continuously variable transmission assembly including a belt rotatably coupling said first pulley and said second pulley;
said first pulley and said second pulley each having an axial contact area where said belt engages said first pulley and said second pulley;
a first clutch rotatably coupled with said first pulley including a first clutch plate and a first clutch brake that selectively engages said first clutch plate to rotatably couple said first clutch plate and said first pulley;
a first gear assembly rotatably coupled with said first clutch plate including a first layshaft rotatably coupled with said first clutch plate;
a second clutch rotatably coupled with said second pulley including a second clutch plate and a second clutch brake that selectively engages said second clutch plate to rotatably couple said second clutch plate and said second pulley;
a second gear assembly rotatably coupled with said second clutch plate including a second layshaft rotatably coupled with said second clutch plate;
said first gear assembly and said second gear assembly each including at least one forward gear;
said second gear assembly including a first forward gear rotatably coupled with said second layshaft and having a first diameter;
said first gear assembly including a second forward gear rotatably coupled with said first layshaft and having a second diameter that is larger than said first diameter;
said second gear assembly including a third forward gear rotatably coupled with said second layshaft and having a third diameter that is larger than said second diameter;
said first gear assembly including a fourth forward gear rotatably coupled with said first layshaft and having a fourth diameter that is larger than said third diameter;
said second gear assembly including a fifth forward gear rotatably coupled with said second layshaft and having a fifth diameter that is larger than said fourth diameter;
said first gear assembly including a sixth forward gear rotatably coupled with said first layshaft and having a sixth diameter that is larger than said fifth diameter;
said second gear assembly including a reverse gear rotatably coupled with said second layshaft;
a third gear assembly disposed in meshing engagement with said first gear assembly and said second gear assembly;
said third gear assembly including an output shaft;
said third gear assembly including a first output gear rotatably coupled with said output shaft and meshingly engaged with said first forward gear, said first output gear having a seventh diameter;
said third gear assembly including a second output gear rotatably coupled with said output shaft and meshingly engaged with said second forward gear, said second output gear having an eighth diameter that is smaller than said seventh diameter;
said third gear assembly including a third output gear rotatably coupled with said output shaft and meshingly engaged with said third forward gear, said third output gear having a ninth diameter that is smaller than said eighth diameter;
said third gear assembly including a fourth output gear rotatably coupled with said output shaft and meshingly engaged with said fourth forward gear, said fourth output gear having an tenth diameter that is smaller than said ninth diameter;
said third gear assembly including a fifth output gear rotatably coupled with said output shaft and meshingly engaged with said fifth forward gear, said fifth output gear having an eleventh diameter that is smaller than said tenth diameter;
said third gear assembly including a sixth output gear rotatably coupled with said output shaft and meshingly engaged with said sixth forward gear, said sixth output gear having an twelfth diameter that is smaller than said eleventh diameter;
said third gear assembly including a reverse output gear rotatably coupled with said output shaft and meshingly engaged with said reverse gear;
said forward gears of said first gear assembly and said second gear assembly having a wide step ratio between consecutive forward gears;
at least one step-gear actuator selectively engaging and disengaging said forward gears of said first gear assembly and said forward gears of said second gear assembly to shift the automatic transmission between consecutive forward gears;
at least one reverse gear actuator selectively engaging and disengaging said reverse gear; and
said continuously variable transmission assembly having at least one pulley actuator selectively adjusting said variable diameter of said first pulley and said variable diameter of said second pulley to provide a first ratio of one to one in response to said at least one step-gear actuator selectively engaging one of said forward gears and said at least one pulley actuator increasing said variable ratio of said continuously variable transmission assembly to a second ratio that is different than said first ratio in response to said at least one step-gear actuator shifting between consecutive forward gears.

26. A method of operating automatic transmission, comprising the steps of:
providing a first forward gear, a second forward gear, and a continuously variable transmission assembly that is rotatably coupled to the first forward gear and the second forward gear, the continuously variable transmission assembly having a variable ratio that is adjusted by at least one pulley actuator;
engaging one of the first forward gear and the second forward gear;
controlling the at least one pulley actuator to set the variable ratio of the continuously variable transmission assembly to a pre-determined ratio when one of the first and second forward gears is engaged;
shifting between the first and second forward gears;
controlling the at least one pulley actuator to change the variable ratio of the continuously variable transmission assembly to a ratio that is different from the pre-determined ratio during the shifting step; and
controlling the at least one pulley actuator to re-set the variable ratio of the continuously variable transmission assembly to the pre-determined ratio after the shifting step has been completed.

27. A method as set forth in claim 26 wherein the pre-determined ratio of the continuously variable transmission assembly is one to one.

28. A method as set forth in claim 26 wherein the at least one pulley actuator changes the variable ratio from the pre-determined ratio progressively with time.

29. A method as set forth in claim 28 wherein the at least one pulley actuator changes the variable ratio from the pre-determined ratio linearly with time.

30. A method as set forth in claim 28 wherein the at least one pulley actuator changes the variable ratio from the pre-determined ratio exponentially with time.

31. A method of operating automatic transmission, comprising the steps of:
providing a first gear assembly with a first forward gear, a second gear assembly with a second forward gear, and a continuously variable transmission assembly that is rotatably coupled to the first gear assembly and the second gear assembly, the continuously variable transmission assembly having a variable ratio that is adjusted by at least one pulley actuator;
engaging the first forward gear of the first gear assembly;
controlling the at least one pulley actuator to set the variable ratio of the continuously variable transmission assembly to a pre-determined ratio when the first forward gear is engaged;
shifting from the first forward gear of the first gear assembly to the second forward gear of the second gear assembly by disengaging the first forward gear and engaging the second forward gear;
controlling the at least one pulley actuator to decrease the variable ratio of the continuously variable transmission assembly to a ratio that is less than the pre-determined ratio during the step of shifting from the first forward gear to the second forward gear; and
controlling the at least one pulley actuator to re-set the variable ratio of the continuously variable transmission assembly to the pre-determined ratio after the step of shifting from the first forward gear to the second forward gear has been completed and when the second forward gear is engaged.

32. A method as set forth in claim 31 further comprising the steps of:
shifting from the second forward gear of the second gear assembly to the first forward gear of the first gear assembly by disengaging the second forward gear and engaging the first forward gear;
controlling the at least one pulley actuator to increase the variable ratio of the continuously variable transmission assembly to a ratio that is greater than the pre-determined ratio during the step of shifting from the second forward gear to the first forward gear; and
controlling the at least one pulley actuator to re-set the variable ratio of the continuously variable transmission assembly to the pre-determined ratio after the step of shifting from the second forward gear to the first forward gear has been completed and when the first forward gear is engaged.

33. A method as set forth in claim 32 wherein the pre-determined ratio of the continuously variable transmission assembly is one to one.

34. A method as set forth in claim 32 wherein the at least one pulley actuator changes the variable ratio from the pre-determined ratio progressively with time.

35. A method as set forth in claim 34 wherein the at least one pulley actuator changes the variable ratio from the pre-determined ratio linearly with time.

36. A method as set forth in claim 34 wherein the at least one pulley actuator changes the variable ratio from the pre-determined ratio exponentially with time.
